(19) United States
(12) Patent Application Publication
(10) Pub. No.: US 2008/0046142 A1
(43) Pub. Date: Feb. 21, 2008

(54) LAYERED ARCHITECTURE SUPPORTS DISTRIBUTED FAILOVER FOR APPLICATIONS

(75) Inventors: PATRICK D. JORDAN, AUSTIN, TX (US); HAI DONG, AUSTIN, TX (US); WALTON L. FEHR, MUNDELEIN, IL (US); HUGH W. JOHNSON, CEDAR PARK, TX (US); PRAKASH U. KARTHA, ROUND ROCK, TX (US); SAMUEL M. LEVENSON, ARLINGTON HEIGHTS, IL (US); DONALD J. REMBOSKI, AKRON, OH (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/427,574

(22) Filed: Jun. 29, 2006

(51) Int. Cl. G06F 7/00

(52) U.S. Cl. 701/36

(57) ABSTRACT

Methods and systems for distributed failover in a vehicle network, including processor load shedding to reallocate processing power to applications controlling critical vehicle functions and providing for failover in a vehicle network according to the criticality of the affected vehicle function. In embodiments of the presently disclosed vehicle control method and system, the components of the system, including sensors, actuators, and controllers, are implemented as nodes in a network or switch fabric capable of communicating with other nodes.

### FIELD OF THE INVENTION

This invention relates to a control network in an automotive vehicle. More specifically, the invention relates to a layered architecture which supports distributed failover.

### BACKGROUND

Vehicle builders have long been using control systems to process vehicle conditions and actuate vehicle devices for vehicle control. Historically, these control systems have included controllers linked by signal wiring or a shared access serial bus, but in the future, switch fabrics may be employed to connect controllers and devices. These switch fabrics provide a multiplicity of paths for data transmission, thereby improving flexibility, reliability, and speed of communication between the components of a control system. Connected by a fabric, components of a vehicle control system such as devices and controllers may send messages to one another through the fabric as data packets. Today, the controller may be implemented as a control application installed and running on a processor. In such a system, the control application processes data from dedicated sensors and responds with control instructions sent as data packets to the controller's dedicated actuators.

Although fault tolerance can be improved with the use of switch fabrics, failure of a control application, and therefore a controller, or the controller itself is still a concern. To this end, redundant system components are used to ensure continuing functionality of critical systems in the case of a failure, but these redundant components result in a significant cost increase and have limited effectiveness. Particularly inefficient are architectures where redundant components sit idle while waiting for a failure.

Moreover, control functions operated by the vehicle control system often have varying levels of criticality. That is, some control functions, because of safety concerns or other factors, are more critical than others. For example, steering and braking are more important to a car's driver than power door-lock control. Using the same failover design for functions having less criticality is even more inefficient than for the most critical situations. Therefore, there is a need for more efficient architectures to handle component failures.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates a vehicle control system according to embodiments of the present invention;

FIG. 2 is a data flow diagram illustrating the function of a vehicle control system according to embodiments of the present invention;

FIG. 3A illustrates a network element according to embodiments of the present invention;

FIG. 3B illustrates a sensor node according to embodiments of the present invention;

FIG. 3C illustrates a actuator node according to embodiments of the present invention;

FIG. 4 illustrates a data packet according to embodiments of the present invention;

FIG. 5 is a flowchart illustrating a method of the network for responding to a computing node failure with a passive backup according to embodiments of the present invention;

FIGS. 6A and 6B are data flow diagrams illustrating a method of the network for responding to a computing node failure with a passive backup according to embodiments of the present invention;

FIG. 7 is a flowchart illustrating a method of the network for responding to a computing node failure with an active backup according to embodiments of the present invention;

FIGS. 8A and 8B are data flow diagrams illustrating a method of the network for responding to a computing node failure with an active backup according to embodiments of the present invention;

FIG. 9 is a flowchart illustrating a method of the network for responding to a computing node failure with a parallel active backup according to embodiments of the present invention;

FIG. 10 is a data flow diagram illustrating a method of the network for responding to a computing node failure with a parallel active backup according to embodiments of the present invention;

FIG. 11 is a data flow diagram illustrating a vehicle control system with processor load shedding according to embodiments of the present invention; and

FIG. 12 illustrates a vehicle control system which utilizes processor load shedding after computing node failure to maintain a highly critical application according to embodiments of the present invention.

### DETAILED DESCRIPTION

Disclosed herein are methods and systems for distributed failover in a vehicle network. More specifically, the present disclosure includes processor load shedding to reallocate processing power to applications controlling critical vehicle functions and providing for failover in a vehicle network according to the criticality of the affected vehicle function.

In embodiments of the presently disclosed vehicle control method and system, the components of the system, including sensors, actuators, and controllers, are implemented as nodes in a network or fabric capable of communicating with any of the other nodes. Therefore any computing node with sufficient processing power, as long as it has initiated the appropriate control application in its processor, is capable of controlling any device. These devices effect the system's control functions, including throttle control, transmission, steering, braking, suspension control, electronic door locks, power window control, etc. These nodes are connected to a computing node through a network or fabric.

In case of computing node failure, responsibility for the devices that were controlled by the failed node may be dynamically reassigned to or assumed by another node.

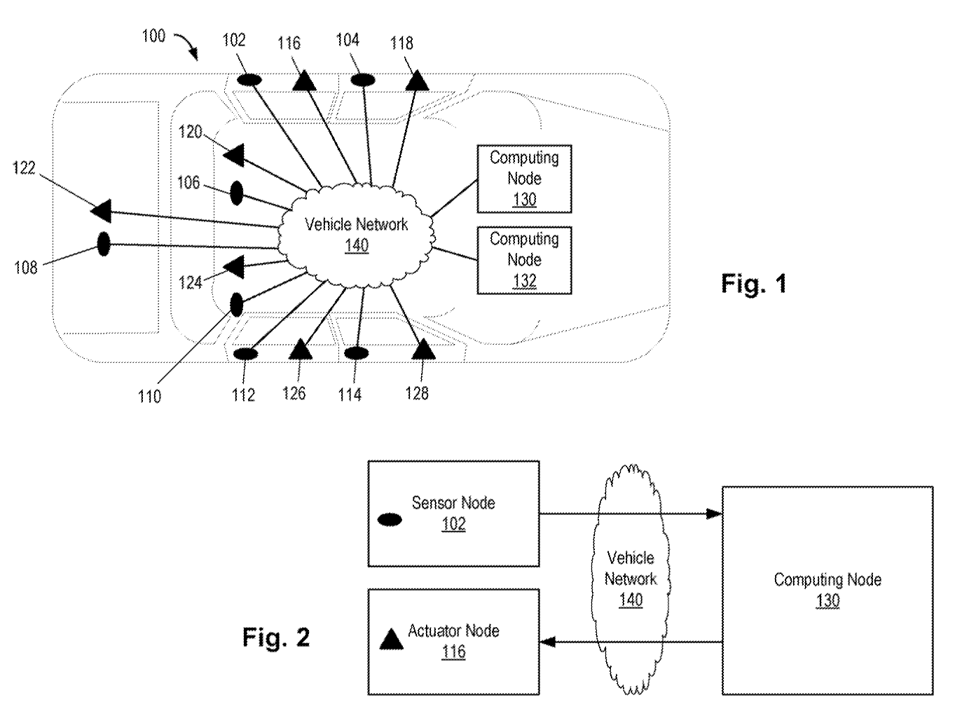

FIG. 1 illustrates a vehicle control system 100 including a vehicle network 140 to which are coupled various sensor nodes 102, 104, 106, 108, 110, 112, 114 and actuator nodes 116, 118, 120, 122, 124, 126, 128. The sensor nodes provide data related to the system's control functions, as described above, to a processor. The actuator nodes actuate devices to carry out control functions of the system to control the vehicle. Also coupled to the vehicle network 140 are at least two computing nodes 130, 132 for receiving vehicle operation input, processing the input, and producing vehicle operation output.

The vehicle network 140 is a packet data network. In one embodiment, the network is formed by a fully redundant switch fabric having dual-ported nodes. Any node connected to the fabric, such as a sensor node 102, 104, 106, 108, 110, 112, 114, actuator node 116, 118, 120, 122, 124, 126, 128, or computing node 130, 132, may communicate with any other node by sending data packets through the fabric along any number of multiple paths. These nodes may transmit data packets using logical addressing. The vehicle network 140, in turn, may be adapted to route the data packets to the correct physical address. This network may be implemented in any fashion as will occur to one of skill in the art, such as a switch fabric, a CAN bus, and so on.

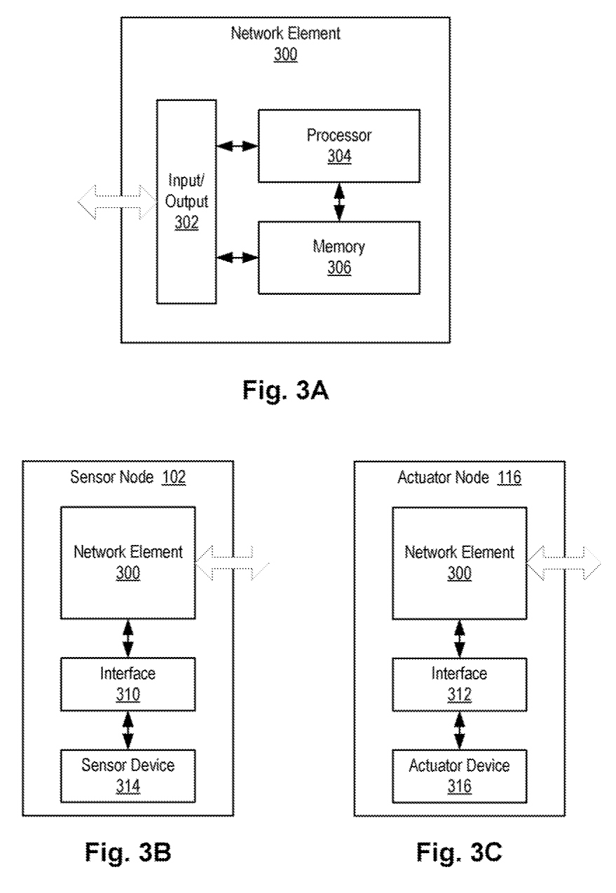

For consistency, the reference numerals of FIG. 1 are used throughout description of the flowchart of FIG. 2. A computing node 130 is a network element (300, FIG. 3A) which executes software instructions for controlling the vehicle. Turning to FIG. 2, the computing node 130 receives as input data sent from the sensor node 102, processes the input according to a vehicle control application designed to control the vehicle, and sends control output to the actuator node 116 to carry out the control of the vehicle. Because the sensor node 102 and actuator node 116 are not required to be directly connected to any particular computing node 130, and vice versa, control of any particular actuator for any particular vehicle function (using data from appropriate sensors) may be dynamically assigned to any computing node having sufficient processing power. Although the computing node 130, sensor node 102, and actuator node 116 typically begin normal operation as separate nodes, any combination of these nodes could be the same node.

As shown in FIG. 3A, a network element 300 includes an input/output port 302, a processor 304, and a memory 306, each operationally coupled to the other. The input/output port 302 is adapted for connecting with the network to receive data packets from the network (140, FIG. 1) as input for the network element 300 and transmit data packets to the network (140, FIG. 1) as output from the network element 300. The memory 306 includes both volatile random access memory (“RAM”) and some form or forms of non-volatile computer memory. The memory 306 contains program instructions (not shown) for vehicle operation. The processor 304 executes these program instructions. In the computing nodes 130, 132, these program instructions, collectively the vehicle control application, process input from the network and provide output over the network to actuators for controlling the vehicle.

Referring to FIG. 3B, a sensor node 102 includes a network element 300, an interface 310, and a sensor device 314. The sensor device 314 provides data regarding the status of the vehicle or one of its components, typically as signals. The sensor device 314 is coupled to the network element 300 by the interface. The interface 310 may be any interface suitable for coupling the sensor to the network element 300. In alternate embodiments, the sensor device couples directly to the network element 300, and an interface 310 is not used. The network element 300 in the sensor node contains program instructions for receiving data transmitted by the sensor device 314 and sending the data as data packets through the vehicle network to a computing node 130.

Referring to FIG. 3C, an actuator node 116 includes a network element 300, an interface 312, and an actuator device 316. The actuator device 316 is coupled to the network element 300 via the interface 312. The actuator device 316 operates to control an aspect of the vehicle according to signals received from the network element 300 via the interface 312. In other embodiments, the actuator device 316 couples directly to the network element 300. The network element 300 in the actuator node 116 contains program instructions for receiving control information sent through the vehicle network from a computing node 130 as data packets and transmitting the control information as signals to the actuator device 316.

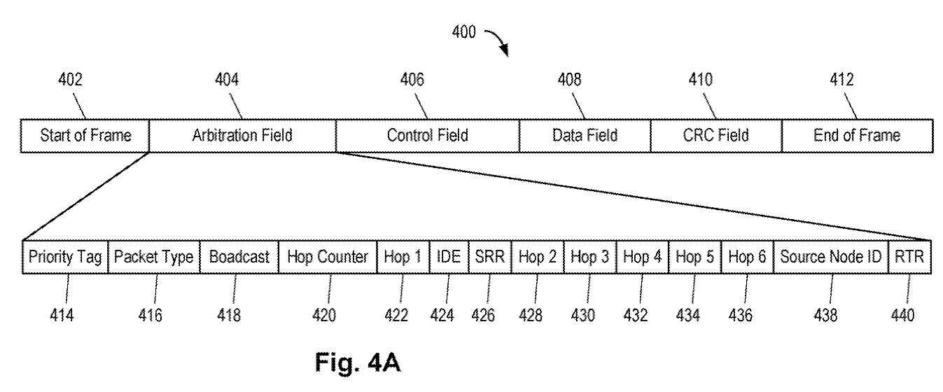

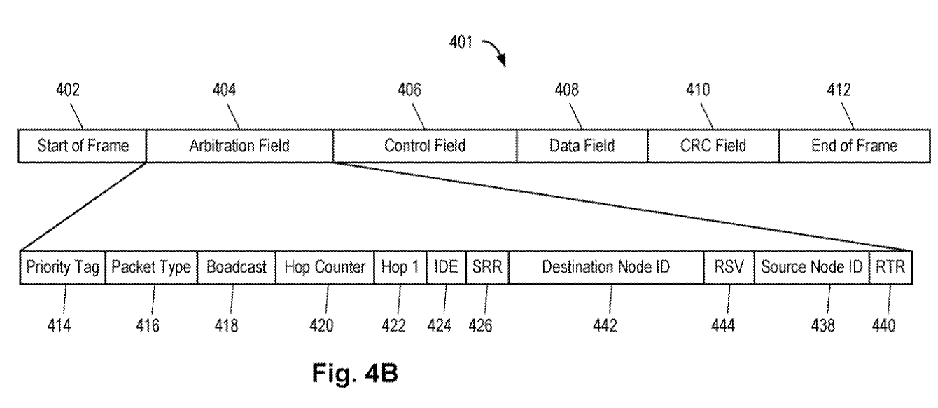

FIGS. 4A and 4B illustrate exemplary embodiments of a data packet of the present invention. The illustrated packet 400 of FIG. 4A is used with source-routing techniques where the designated switch hops are provided to traverse the fabric from the source to the destination. Alternatively, packet 401 of FIG. 4B includes a destination node ID field to allow self-routing techniques to be used. In other embodiments, other routing techniques and their related packet addressing may also be utilized.

Referring to FIG. 4A, data packet 400 includes a start of frame field 402, an arbitration field 404, a control field 406, a data field 408, a cyclical redundancy-check (“CRC”) field 410, and an end of frame field 412.

Arbitration field 404 may contain a priority tag 414, packet type identifier 416, a broadcast identifier 418, a hop counter 420, hop identifiers 422, 428-436, an identifier extension bit, 424, a substitute remote request identifier 426, a source node identifier 438, and a remote transmission request identifier 440. The priority tag 414 may be used to ensure that high priority messages are given a clear path to their destination. Such high priority messages could include messages to initiate or terminate failover procedures. The packet type identifier 416 may identify the packet's purpose, such as discovery, information for processing in a control application, device commands, failover information, etc. The broadcast identifier 418 identifies if the packet is a single-destination packet. This bit is always unset for source routing. The hop counter 420 is used in source routing to determine whether the packet has arrived at its destination node. Hop identifiers 422, 428-436 identify the ports to be traversed by the data packet. The source node identifier 428 identifies the source of the packet. The identifier extension bit 424, substitute remote request identifier 426, and remote transmission request identifier 440 are used with CAN messaging.

Referring to FIG. 4B, data packet 401 contains similar data fields to data packet 400, including a start of frame field 402, an arbitration field 404, a control field 406, a data field 408, a CRC field 410, and an end of frame field 412.

Arbitration field 404 of data packet 401 contains most of the same identifiers as data packet 400. Arbitration field 404 of data packet 401, however, may contain a destination node identifier 442 and a reserved field 444 instead of hop identifiers 422, 428-436. The hop counter 420 is used in destination routing to determine whether the packet has expired.

In some embodiments, the destination node identifier 442 contains logical address information. In such embodiments, the logical address is converted to a physical address by the network. This physical address is used to deliver the data packet to the indicated node. In other embodiments, a physical address is used in the destination node identifier, and each source node is notified of address changes required by computing node reassignment resulting from failover.

Thus, as described in reference to FIG. 2, control of any particular actuator node for any particular vehicle control function may be dynamically assigned to any computing node, along with the sensor data associated with the control function. The initial assignment may be easily reassigned if an application running in a computing node fails, so that another computing node may assume the role of the failed node. In some embodiments, multiple levels of failover may be implemented for an application to protect against multiple failures. Distributed failover may be implemented in various ways, using varying amounts of processing power. Typically, the more seamless the transfer of control between computing nodes, the more processing power that must be dedicated to the system.

As discussed above, control functions operated by the vehicle control system 100, may have varying levels of criticality. For the most critical vehicle functions, it is important that interruptions in operation are as short as possible. For non-critical vehicle functions, short interruptions may be acceptable. Vehicle functions of intermediate criticality require a shorter response time than non-critical functions, but do not require the fastest possible response. In some embodiments, therefore, failover methods for control functions are determined according to the criticality of the function, so that the function is restored as quickly as required, but more processing power than necessary is not expended.

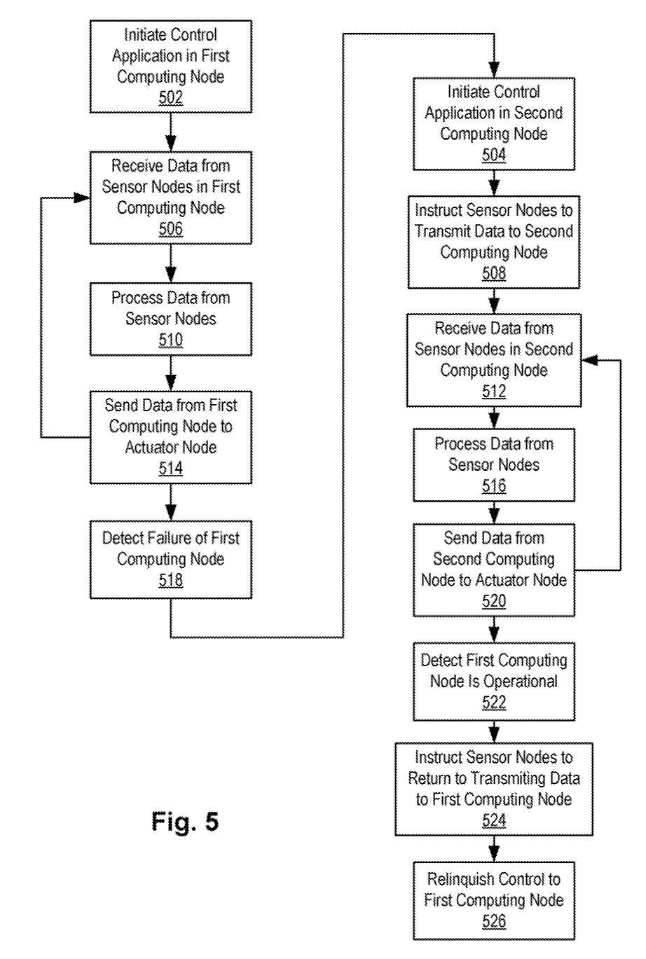

In some embodiments, a passive backup may be employed for control functions that have a low criticality. FIG. 5 illustrates a method of the network responding to a computing node failure with a passive backup. The first step of this method is to initiate a control application in a first computing node (block 502). In normal operation, the application in the first computing node receives data from one or more sensor nodes (block 506), processes this data from the sensor nodes (block 510), and sends data from the first computing node to an actuator node (block 514) to control the vehicle.

Upon detecting the failure of the first computing node (block 518), the network initiates a control application in a second computing node (block 504), typically by sending a data packet to the second computing node. The control application (or a reduced version of the application) may be installed on the second computing node at manufacture, may be sent to the second computing node just before the application is initiated, may have a portion of the application installed at manufacture and receive the rest just before initiation, and so on. Detecting the failure may be carried out by the use of a network manager (not shown). In one embodiment, all applications on the nodes send periodic heartbeat messages to the network manager. In another embodiment, all the nodes are adapted to send copies of all outgoing data to a network manager, and the network manager is adapted to initiate the control application in a second computing node upon failure to receive expected messages. The network manager may also poll each application and initiate the control application upon failure to receive an expected response. In some networks, each node may poll its neighboring nodes or otherwise determine their operative status. The nodes may also receive updated neighbor tables and initiate a failover according to configuration changes.

In other embodiments, after sending a message to a first computing node, the message source, such as a sensor node, may initiate the control application in a second computing node upon failure to receive an expected message response from the first computing node. Alternatively, a message destination, such as an actuator node, may initiate the control application upon failure to receive expected messages from the first computing node. The nodes may initiate the application directly or notify a network manager adapted to initiate the application.

Once the control application is initiated, the second computing node instructs the sensor nodes previously transmitting data to the first computing node to instead send the data to a second computing node (block 508). This instruction may be carried out by sending data packets from the second computing node. Instead of the second computing node, in other embodiments the network manager or a node detecting the failure may instruct the sensor nodes to send data to the second computing node. This redirection can occur by many different techniques. In one embodiment the sensor node simply changes the destination node ID of its outgoing data packets. If the destination node ID is a logical value, the network routing tables may be reconfigured to direct packets addressed to that logical node ID to the second computing node rather than the first computing node. In another embodiment, the second computing node adopts the destination node ID of the first computing node as a second node ID, with related changes in network routing. Other techniques will be recognized by those skilled in the art.

Operating in place of the first computing node, the application in the second computing node receives data from one or more sensor nodes (block 512), processes this data from the sensor nodes (block 516), and sends data from the first computing node to an actuator node (block 520).

Upon detecting that the first computing node is operational (block 522), the second computing node instructs the sensor nodes initially sending data to the first computing node to return to transmitting data to the first computing node (block 524) or other rerouting as described above. The second computing node then relinquishes control to the first computing node (block 526), by transmitting a data packet to the first computing node to resume control at a specific time stamp, for example. In other embodiments, the backup may retain the application until the next key off, or other condition, before releasing control back to the operational first computing node.

This failover or backup capability provided by transferring control operations to an existing controller improves failover system efficiency by providing failover capabilities without providing a fully redundant environment.

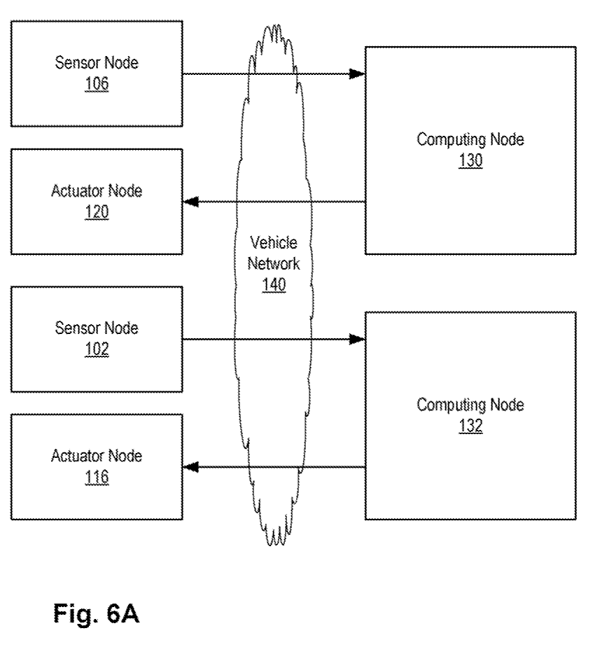

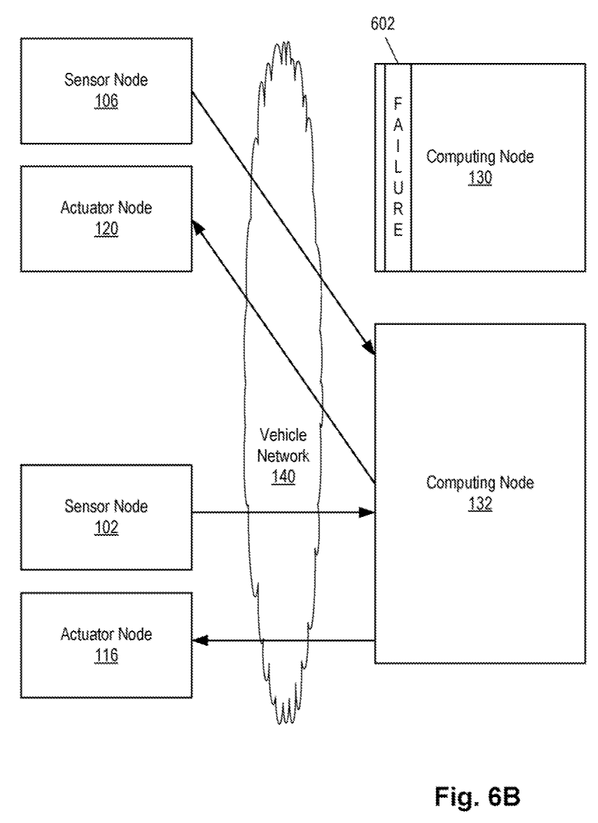

FIGS. 6A and 6B show a data flow diagram of an exemplary vehicle control system before (FIG. 6A) and after (FIG. 6B) a computing node failure. The vehicle control system employs the method of FIG. 5. In FIG. 6A, sensor nodes 106 and 102 send messages over vehicle network 140 to computing nodes 130 and 132, respectively. Computing nodes 130 and 132 process this data and send messages over vehicle network 140 to actuator nodes 120 and 116, respectively. In FIG. 6B, upon the failure 602 of computing node 130, computing node 132 receives data from sensor node 106 as well as sensor node 102 and sends data to actuator node 120 in addition to actuator node 116. A passive backup is appropriate for vehicle functions such as, for example, power window control, power door-lock control, seating adjustment control, mirror adjustment control, and so on.

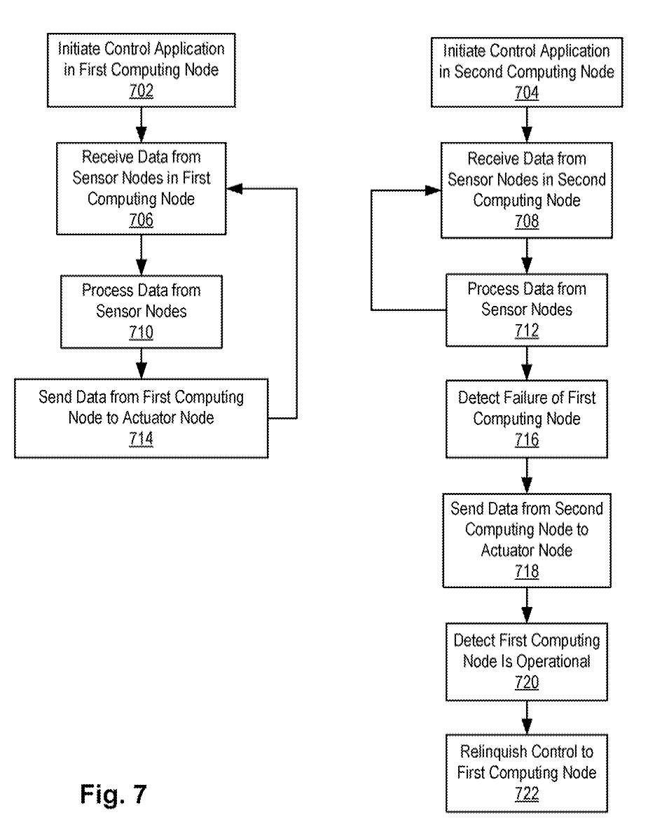

An active backup may be implemented for control functions with an intermediate criticality level, such as, for example, powertrain function. FIG. 7 illustrates a network method for responding to a computing node failure with an active backup. The method includes initiating a control application in both a first computing node (block 702) and a second computing node (block 704).

In normal operation, the control applications in the first and second computing nodes each receive data from one or more sensor nodes (block 706, 708) and process this data from the sensor nodes (block 710, 712). This dual delivery can be done by the sensor node transmitting two identical packets, except that one is addressed to the first computing node and the other is addressed to the second computing node. Alternatively, one of the switches in the fabric may replicate or mirror the data packets from the sensor node. Again, other techniques will be apparent to those skilled in the art. Thus, the second control application maintains an equal level of state information and may immediately replace the first application if it fails. Only the control application from the first computing node, however, sends data to an actuator node (block 714).

Upon detecting the failure of the first computing node (block 716), the application running in the second computing node assumes the function of the first computing node. The second application may detect the failure by polling, by failure to receive an expected message or by other methods as will occur to those of skill in the art. In other embodiments, detecting the failure may be carried by other nodes or by a network manager as described above. Operating in place of the first computing node, the application in the second computing node sends data from the first computing node to an actuator node (block 718). Upon detecting that the first computing node is operational (block 720), the second computing node relinquishes control to the first computing node (block 722).

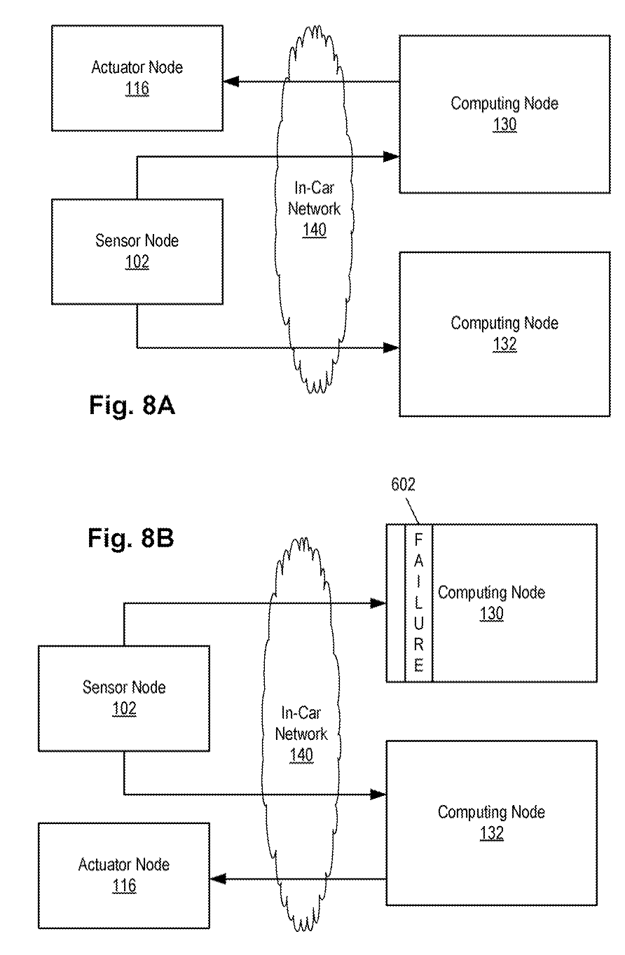

FIGS. 8A and 8B show a data flow diagram of an exemplary vehicle control system before (FIG. 8A) and after (FIG. 8B) a computing node failure. The vehicle control system employs the method of FIG. 7. In FIG. 8A, sensor node 102 sends messages over vehicle network 140 to computing nodes 130 and 132. Only computing node 130, however, sends messages over vehicle network 140 to actuator node 116. In FIG. 8B, upon the failure 602 of computing node 130, computing node 132 replaces computing node 130, sending data to actuator node 116.

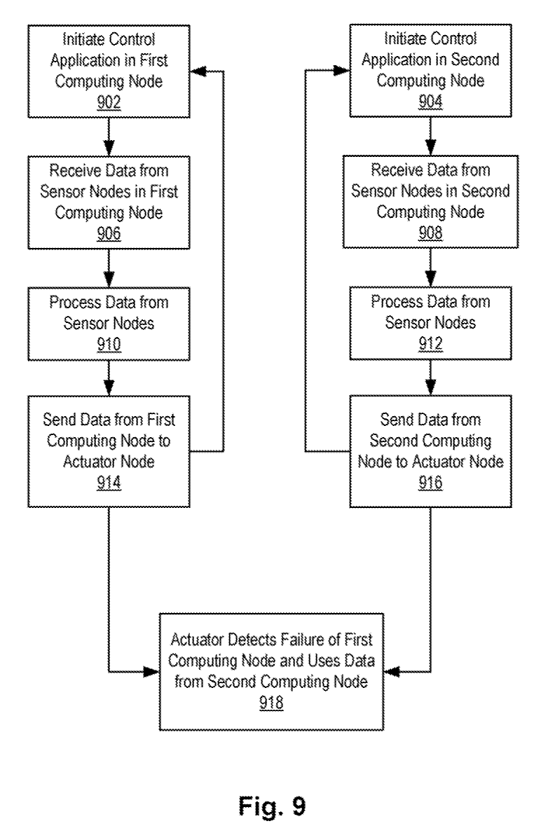

For the most critical control functions, such as steering and braking, for example, the system may employ a parallel active backup. FIG. 9 is a flowchart illustrating a network method for responding to a computing node failure with a parallel active backup. The method includes initiating a control application in both a first computing node (block 902) and a second computing node (block 904).

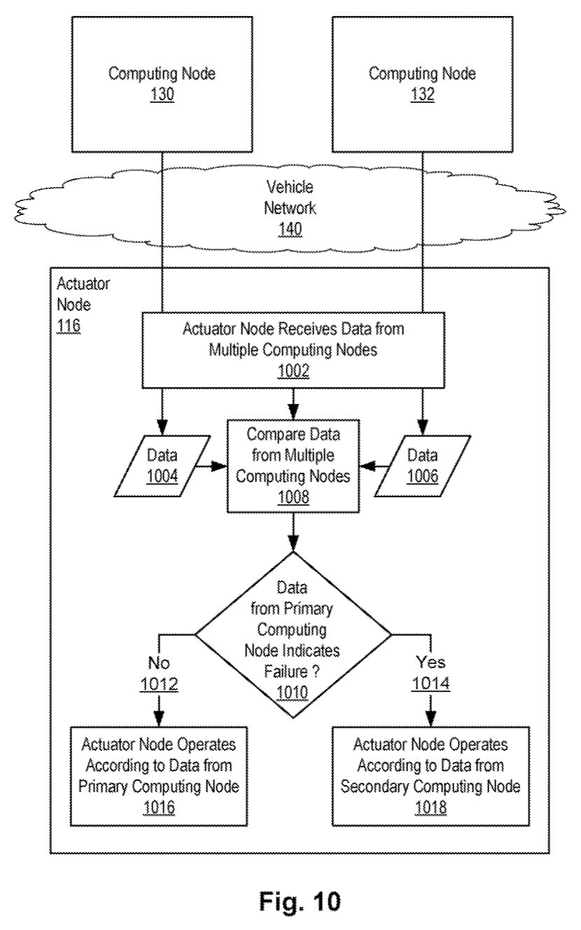

The applications in each of the first and second computing nodes receive data from one or more sensor nodes (block 906, 908), process this data from the sensor nodes (block 910, 912), and send data to an actuator node (block 914, 916). The actuator node is adapted to determine which application is sending control data. Upon detecting the failure of the first computing node, the actuator uses data from the second computing node (block 918), as further illustrated in FIG. 10.

FIG. 10 is a data flow diagram illustrating a network method for responding to a computing node failure with a parallel active backup. Computing nodes 130 and 132 send data to the actuator node 116 through a vehicle network 140. The actuator node 116 receives the data 1004 and 1006 from computing nodes 130 and 132, respectively (block 1002). The actuator node 116 compares data 1004 and 1006 from multiple computing nodes 130 and 132 (block 1008) by determining if the data from the primary computing node 130 indicates failure (block 1010). If so, (1012), the actuator node 116 operates using this data (block 1016). If not (1014), then data 1006 from the secondary computing node 132 is used (block 1018).

The system as described above may be designed with redundant processing power which, when all of the system's components are operating properly, goes unused. As failure occurs, the system draws from this unused processing power for backup applications. This redundant processing power may be assigned according to the priority of the applications. In some embodiments, if the total amount of redundant processing power is not sufficient to keep all control functions operational, the system frees processing power allocated for control functions of lesser criticality and uses this processing power for more critical backup applications.

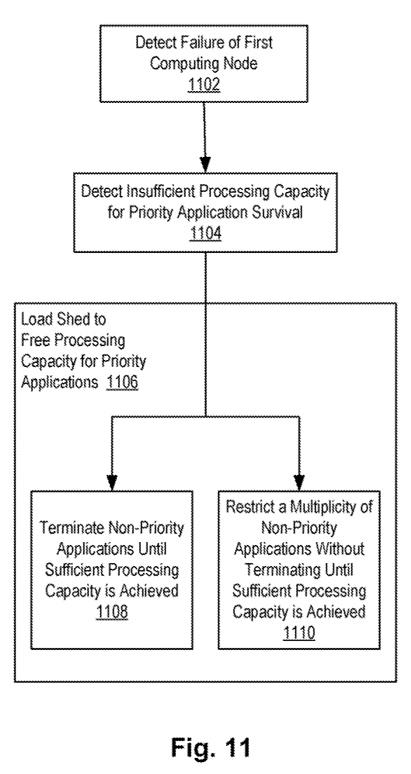

FIG. 11 is a data flow diagram illustrating a vehicle control system with processor load shedding. Upon detecting failure of a computing node running an application (block 1102) and detecting insufficient processing capacity for the survival of higher priority applications (block 1104), the system load sheds to free processing capacity for higher priority applications (block 1106).

The vehicle control system may detect insufficient processing capacity by determining that more system resources are required to initiate a backup control application than are available. The system may also find the system resources required by a particular control in a hash table. This data may be pre-determined for the particular application or calculated periodically by network management functions and updated. The system's available processing capacity may be determined according to various network management techniques that are well-known to those of skill in the art.

An application has a higher priority than another application if it is determined that the vehicle function the application controls is more important to the vehicle's operation than the vehicle function of another application, denoted by a priority value indicating a higher priority than the priority value of the other application. A higher or lower priority value may indicate a higher priority depending on the scheme for assigning priority values. Determining priority typically includes performing look-ups of a priority value and comparing the results of the look-up. The hierarchy of applications, as reflected in priority values, may be predetermined and static, or it may be dynamically ascertained according to valuation algorithms immediately prior to load shed or periodically during operation. Dynamically assigning priority values may be carried out in dependence upon vehicle conditions, such as, for example, the speed of the vehicle, the rotational speed of each wheel, wheel orientation, engine status, and so on. In this way, the priority values of the applications may be changed to reflect an application hierarchy conforming to circumstances of vehicle operation.

Processor load shedding may be carried out by terminating lower priority applications until there is sufficient processing capacity to run the backup (block 1108) or restricting a multiplicity of lower priority applications to lower processing demands without terminating those applications (block 1110). Determining when to load shed and which applications will be restricted or terminated may be carried out in the nodes running the affected applications or in a network manager.

Referring again to FIG. 6A, an exemplary vehicle control system is shown in operation before a computing node failure occurs. Computing node 130 runs a braking control application (not shown). Computing node 132 runs an application for power window control (not shown). Before failure, there exists sufficient processing power for both applications. Sensor node 106 sends messages carrying braking related information over vehicle network 140 to computing node 130. Computing node 130 processes this data and sends braking control messages over vehicle network 140 to braking actuator node 120. Sensor node 102 sends messages carrying information related to power window function over vehicle network 140 to computing node 132. Computing node 132 processes this data and sends power window control messages over vehicle network 140 to power window actuator node 116.

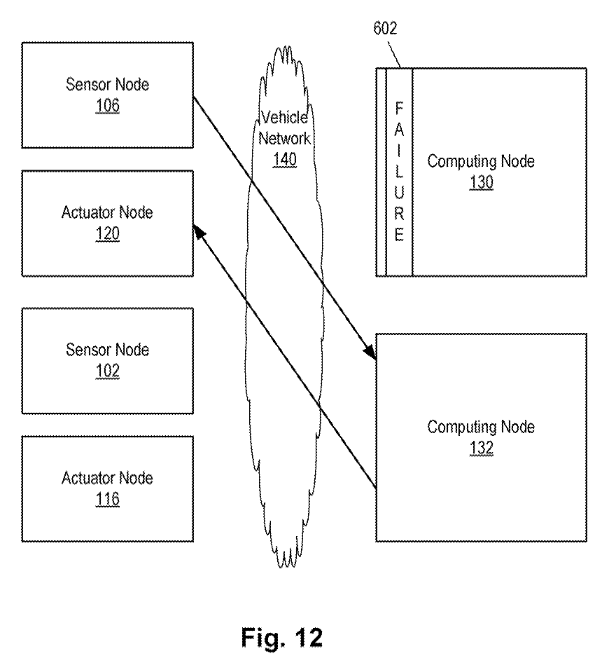

FIG. 12 shows a vehicle control system which utilizes processor load shedding after computing node failure to maintain a highly critical application. Upon the failure 602 of computing node 130, the lower priority application for power window control in computing node 132 is terminated. Computing node 132 initiates a braking control application (not shown), and sensor node 102 is notified to cease sending messages. Computing node 132, in place of failed computing node 130, receives braking-related data from sensor node 108, processes the data with the braking control application and sends braking control messages to actuator node 122.

This processor load shedding improves efficiency by reducing the amount of unused computing resources provided for failover or backup use. When combined with the failover or backup operations described above, such as the passive backup operations of FIG. 5, system redundancy is provided with a minimum of unused redundant capabilities.

While the embodiments discussed herein have been illustrated in terms of sensors producing data and actuators receiving data, those of skill in the art will recognize that an actuator node may also produce and transmit data, such as data regarding the actuator node's status, and a sensor node may also receive data.

It should be understood that the inventive concepts disclosed herein are capable of many modifications. To the extent such modifications fall within the scope of the appended claims and their equivalents, they are intended to be covered by this patent.

What is claimed is:

1. A method for vehicle control wherein vehicle devices are controlled by one of a plurality of computing nodes assigned to control one or more vehicle devices, with each computing node running a control application adapted to control the one or more vehicle devices based on input data from one or more input sources to effect a vehicle function, wherein the method comprises:
initiating a first control application for a vehicle function in a first computing node;
receiving in said first computing node messages containing input data from an input source;
processing said input data in said first control application to determine a control output;
sending messages containing said control output from said first control application to the appropriate vehicle devices to control the vehicle devices; and
implementing a failover measure in dependence upon a criticality of said first control application.

2. The method of claim 1 wherein implementing said failover measure in dependence upon said criticality of said first control application includes:
upon detecting failure of said first computing node, initiating a backup control application for the vehicle function in a second computing node; and thereafter
redirecting messages containing input data from the input source from said first computing node to said second computing node;
receiving said messages containing input data in said second computing node;
processing said input data in said backup control application being run on said second computing node to determine a control output; and
sending messages containing said control output from said backup control application to the appropriate vehicle devices to control the vehicle devices.

3. The method of claim 2 wherein redirecting said messages containing input data from the input source from said first computing node to said second computing node includes sending messages from the input source directly addressed to said second computing node.

4. The method of claim 1 wherein implementing said failover measure in dependence upon said criticality of said first control application includes:
initiating a backup control application for the vehicle function in a second computing node, said backup control application for concurrently processing input data identically to said first control application to determine a second control output without sending messages containing said second control output;
routing messages containing input data to said second computing node in addition to said first computing node;
receiving said messages containing said input data in said second computing node;
concurrently processing, identically to said first control application, said input data in said backup control application to determine a control output; and
upon detecting failure of said first computing node, sending messages containing said control output to vehicle devices from said backup control application to control the one or more vehicle devices formerly controlled by said first control application.

5. The method of claim 1 wherein implementing said failover measure in dependence upon said criticality of said first control application includes:
initiating an identical backup control application for the vehicle function in a second computing node;
routing messages containing input data to said second computing node in addition to said first computing node;
receiving said messages containing said input data in said second computing node;
processing said input data in said backup control application being run on said second computing node to determine a control output;
sending messages containing said control output from said backup control application to the same vehicle devices as receiving messages containing control outputs from said first control application;
determining, in a vehicle device, if said first computing node has failed; and
upon detecting failure of said first computing node, controlling said vehicle device according to said second control output from said control application rather than said first control output from said first control application.

6. A vehicle control system for a vehicle comprising:
a plurality of nodes;
a vehicle network interconnecting said plurality of nodes, said vehicle network operating according to a communication protocol;
a plurality of vehicle devices for controlling the vehicle, with each of said vehicle devices being coupled to at least two of said nodes through said vehicle network;
a plurality of vehicle sensors for providing input data to at least two nodes through said vehicle network;
processors at two or more of said nodes, with a first processor running a first control application for controlling vehicle devices assigned to that processor to effect a vehicle function, with said control application including program instructions for processing received input from one or more vehicle sensors to obtain a first result and for sending control messages to an assigned vehicle device according to said first result; and
program instructions running on a processor for reassigning control of said vehicle devices to a second processor in dependence upon a criticality of said vehicle function in the case that said first processor fails.

7. The vehicle control system of claim 6 wherein said program instructions running on said processor for reassigning control of said vehicle devices to said second processor include program instructions for
reconfiguring the vehicle control system to have messages from said vehicle devices sent to said second processor; and
initiating a second control application in said second processor;
wherein said second control application includes program instructions for receiving input data from said vehicle sensors;
processing received input data from said vehicle sensors to obtain a second result; and
sending control messages to the assigned vehicle device according to said second result.

8. The vehicle control system of claim 7 wherein said program instructions for reconfiguring the vehicle control system to have messages from said vehicle devices sent to said second processor include program instructions for the vehicle devices to send messages directly addressed to said second processor.

9. The vehicle control system of claim 7 wherein said program instructions for reconfiguring the vehicle control system to have messages from said vehicle devices sent to said second processor include program instructions for reconfiguring said vehicle network to route messages to said second processor.

10. The vehicle control system of claim 6 further comprising:
a redundant control application being run on the second processor for controlling said vehicle devices assigned to that processor, with said redundant control application including program instructions for processing input data to obtain a second result, but not send control messages;
wherein said program instructions running on said processor for reassigning control of devices to said second processor comprise program instructions for notifying said redundant control application to send control messages to said assigned vehicle device according to said second result.

11. The vehicle control system of claim 6 further comprising:
a second processor running a redundant control application for controlling said vehicle devices assigned to that processor, with said redundant control application including program instructions for processing input data identical to received input data processed by said control application being run on said first processor to obtain a second result and for sending control messages to said assigned vehicle device according to said result; and
a third processor in the assigned vehicle device, with said third processor running program instructions, the program instructions including:
instructions for processing received control messages from said first and second processors to determine if said node containing said first processor has failed;
instructions for utilizing control messages from said first processor if said node containing said first processor has not failed and for utilizing control messages from said second processor if said node containing said first processor has failed; and
instructions for controlling said coupled vehicle devices according to the utilized control message.

12. The vehicle control system of claim 6 wherein said program instructions being run on said processor for reassigning control of said vehicle devices are substantially run on a processor dedicated to managing the vehicle control system.

13. The vehicle control system of claim 6 wherein said program instructions being run on said processor for reassigning control of said vehicle devices are substantially run on said second processor.

14. A method for distributed failover in a vehicle control system wherein actuators are controlled by one of a plurality of computing nodes receiving input data from sensors, with each computing node running a control application to process the input, and each computing node is assigned to control one or more actuators to effect a vehicle function, wherein the method comprises:
detecting failure of a first computing node running a first control application;
initiating a backup control application on a second computing node;
routing messages containing input data from the sensors providing input data from the first computing node to the second computing node; and
reassigning control of the one or more actuators controlled by the first computing node to the second computing node.

15. The method of claim 14 further comprising:
determining that more system resources are required to initiate said backup control application than are available on the second computing node;
determining that the vehicle function of said first control application being run on the first computing node is of a higher priority than the vehicle function of a second control application currently being run on the second computing node; and
terminating the second control application being run on the second computing node prior to initiating the backup control application in the second computing node.

16. The method of claim 15 wherein determining that the vehicle function of the first control application is of a higher priority than the vehicle function of the second control application currently being run on the second computing node includes comparing a pre-defined priority value for each vehicle function.

17. The method of claim 15 wherein determining that the vehicle function of the first control application is of a higher priority than the vehicle function of the second control application comprises:
determining the priority value of each vehicle function in dependence upon vehicle conditions; and
comparing said priority value for each vehicle function.

18. The method of claim 14 further comprising:
determining that more system resources are required to initiate the backup control application on the second computing node than are available;
determining that the vehicle function of the first control application being run on the first computing node is of a higher priority than the vehicle function of a second control application currently being run on the second computing node; and
restricting the second control application currently being run on the second computing node to lower processing demands prior to initiating the backup control application in the second computing node.

19. The method of claim 18 wherein determining that the vehicle function of the first control application is of a higher priority than the vehicle function of the second control application being executed on the second computing node comprises comparing a pre-defined priority value for each vehicle function.

20. The method of claim 18 wherein determining that the vehicle function of the first control application is of a higher priority than the vehicle function of the second control application comprises:
determining the priority value of each vehicle function in dependence upon vehicle
conditions; and
comparing said priority value for each vehicle function.
